(19) United States
(12) Patent Application Publication
(10) Pub. No.: US 2025/0242681 A1
(43) Pub. Date: Jul. 31, 2025

(54) ROTARY ELECTRIC MACHINE FOR A VEHICLE

(71) Applicant: Valeo eAutomotive Germany GmbH, Erlangen (DE)

(72) Inventors: Mathilde POMMIER, Etaples-sur-Mer (FR); Ludovic DOFFE, Etaples-sur-Mer (FR); Céline CUCHEVAL, Etaples-sur-Mer (FR); Vincent MOURET, Etaples-sur-Mer (FR); Paul FROGER, Etaples-sur-Mer (FR); Ruthraapathi KRISHNARAJAN, Chennai (IN); Daniel BOUCLET, Etaples-sur-Mer (FR)

(73) Assignee: Valeo eAutomotive Germany GmbH, Erlangen (DE)

(21) Appl. No.: 19/040,562

(22) Filed: Jan. 29, 2025

(30) Foreign Application Priority Data
Jan. 30, 2024 (FR) FR2400882

(51) Int. Cl. B60K 6/26

(52) U.S. Cl. CPC B60K 6/26; B60Y 2306/01

(57) ABSTRACT

A rotary electric machine for a vehicle includes a housing, a rotor/stator assembly housed in the housing and at least one fastening flange integrally formed with the housing and configured to mechanically connect the rotary electric machine to a combustion engine of the vehicle. A fastening flange includes a body provided with a receiving opening for a fastening mechanism centred about a fastening axis, and at least one tab connecting the body to the housing. The fastening flange includes at least one incipient break formed on the tab and configured so that the tab breaks in the event that the vehicle undergoes a violent impact.

The present invention relates to the field of automotive vehicles, and relates more particularly to a rotary electric machine incorporated into such automotive vehicles.

In the automotive field, rotary electric machines are commonly used as a starter-alternator and as such interact with the combustion engine of said vehicle. The starter-alternator performs both a function of starting the combustion engine, when the vehicle is stopped, via a belt connecting the rotary electric machine to the crankshaft of the combustion engine, and an alternator function when the vehicle is running, consisting in recovering the mechanical energy from the combustion engine in order to generate electrical energy making it possible for example to power any electric element of the vehicle.

It will be understood from the above that in light of the interactions between the rotary electric machine and the combustion engine, these two elements are positioned close to each other and must be mechanically connected together in a precise, durable manner, thus forming an engine assembly in the engine compartment of the vehicle. This means that the rotary electric machine must be placed as close as possible to the combustion engine and in particular that at least one fastening flange must be provided on the housing of the rotary electric machine, by means of which the rotary electric machine is fastened to the combustion engine. More particularly, a fastening flange of the rotary electric machine is arranged facing a fastening flange of the combustion engine and appropriate fastening means, for example a fastening screw, make it possible to fix the position of the rotary electric machine relative to the combustion engine and to then ensure the correct positioning of the transmission belt between these two elements of the engine assembly. This position of the rotary electric machine as close as possible to the combustion engine can mean that the former is positioned facing certain fragile components of the combustion engine, such as for example a protective casing of an intake manifold of the combustion engine.

The design of automotive vehicles, and in particular the arrangement of the engine compartment at the front of automotive vehicles, must take into account the behaviour of the different components provided on the vehicle when the vehicle undergoes a violent impact, and in particular a front impact, for example as a result of an accident. In the context mentioned above of a starter-alternator arranged facing a protective casing of an intake manifold, the positioning and the behaviour of the starter-alternator when the vehicle undergoes an impact must be very particularly designed in order to prevent the deformation of the connection between combustion engine and the starter-alternator and a hazardous movement of the starter-alternator that might cause it and the intake manifold to strike each other, the protective casing being conventionally made from a material and having a thickness such that it cannot withstand such a strike. The aim is thus to avoid the creation of a potential fuel leak on the intake manifold that might lead to extremely serious consequences, such as an explosion or a fire, particularly if the impact is due to an accident.

The present invention falls within this context and as such proposes a rotary electric machine for a vehicle, comprising a housing, a rotor/stator assembly housed in said housing and at least one fastening flange integrally formed with the housing and configured to mechanically connect the rotary electric machine to a combustion engine of said vehicle, the fastening flange comprising a body provided with a receiving opening for fastening means centred about a fastening axis, and at least one tab connecting the body to the housing, characterized in that the fastening flange comprises at least one incipient break formed on the tab and configured so that said tab breaks in the event that the vehicle undergoes a violent impact.

Due to the presence of the incipient break in the tab of the fastening flange, the invention makes it possible, in the event that the vehicle undergoes a violent impact and there are relative movements specific to each of the different components of the engine assembly under the effect of the impact, to detach the rotary electric machine from the combustion engine via a controlled mechanical break. This ensures that the connection between the rotary electric machine and the combustion engine is broken in a predictable manner, according to the predictions made by the designers of the front compartment of the automotive vehicle, leaving a portion of the tab connected to the combustion engine via the fastening means, which thus makes it possible to ensure that the housing of the rotary electric machine, and the tab portion remaining attached to the housing, move under the effect of the impact without striking the combustion engine and in particular the protective casing of the intake manifold.

The rotor/stator assembly comprises a stator and a rotor configured to rotate in or around the stator. Depending on the operating mode of the rotary electric machine, the rotor can be rotated by the magnetic flux generated by the supply of electricity to a winding of the stator, and then transmit the mechanical energy to the combustion engine via a transmission belt driven by the rotation of an output shaft of the rotor, or conversely the rotor can be rotated via the movement of the transmission belt and the movement of the rotor generates a magnetic flux that is converted via the electrical connection of the winding of the stator into an electrical current available for the electric components of the vehicle. The housing in which the rotor/stator assembly is housed ensures mechanical protection, stability of the rotor/stator assembly, and optionally vibration resistance.

The fastening flange is integrally formed with the housing insofar as the housing is for example produced by casting, if applicable by injection, and the part that results from this manufacturing process incorporates said flange. This fastening flange forms a lateral protrusion from the housing.

The body of the fastening flange can have an annular shape defining the receiving opening of said fastening flange and centred about the fastening axis. The combustion engine can also comprise such a type of fastening flange, an opening of which is also centred about the fastening axis. The fastening means connecting the rotary electric machine to the combustion engine is in particular a reversible fastening means, which can be a threaded rod passing through all of the fastening flanges and bolted at each end.

The tab forms the connection between the housing and the body. A fastening flange can comprise one or more tabs. The tab thus contributes to the mechanical connection between the rotary electric machine and the combustion engine. This tab is sized so as to ensure the strength of the fastening flange when the vehicle is running, and to ensure that the rotary electric machine remains in the desired theoretical position relative to the combustion engine through the service life of the vehicle, or in any event throughout the service life of the rotary electric machine and/or of the combustion engine, unless the vehicle undergoes a violent impact. In particular, the thickness of the fastening tab, measured along the axial direction defined by the fastening axis associated with the fastening flange, is substantially equivalent to the thickness of the body of the fastening flange.

As the incipient break is formed on the tab, it is therefore the tab that breaks in the event that the vehicle undergoes a violent impact. More particularly, during such an impact, the presence of the incipient break makes it possible to ensure that the tab breaks with part of the tab, arranged between the incipient break and the body of the fastening flange, remaining in place on the combustion engine, and another part of the tab remaining integral with the housing and moving with it away from the body of the fastening flange.

The incipient break can take the form of a notch or groove formed in the thickness of the material of the tab. As mentioned, this incipient break makes it possible to promote the breaking of the tab in the event of an impact. However, it should be noted that the incipient break is shaped and sized so that the tab only breaks in the event that the vehicle undergoes a violent impact, and not during the normal operation of the engine assembly. In particular, the incipient break must not weaken the fastening tab when the engine assembly undergoes vibrations due to the running of the vehicle and/or when the vehicle encounters a low-intensity impact, for example during a parking manoeuvre. In other words, the shape and size of the incipient break must be determined by reaching a compromise between the desire for a controlled break in the event of a violent impact and the need for mechanical strength of the fastening of the rotary electric machine to the combustion engine in standard operating mode, without the vehicle undergoing a violent impact.

Here, a violent impact undergone by the vehicle can be defined as a function of the speed of the vehicle before impact or as a function of the energy released during the impact, either by the value of the impact force or the number of Gs experienced during the deceleration due to the impact.

According to one feature of the invention, the fastening flange comprises a first face and a second face on the opposite side from the first face, the first face and the second face being perpendicular to the fastening axis, the incipient break being positioned on the first face or on the second face. The first face and the second face should be considered for the fastening flange as a whole, such that mention can be made of a first face of the body and of the tab of the fastening flange and a second face of the body and of the tab of this fastening flange, on the opposite side from the first face of the body and of the tab of the fastening flange.

According to one feature of the invention, the incipient break is positioned on the face that is facing an area in which an impact of the vehicle is most probable. In other words, for a rotary electric machine according to the invention present in a front compartment of an automotive vehicle and the behaviour during a front impact of which is subject to particular attention, the incipient break is positioned on the face that is facing towards the front of the vehicle. However, for reasons of footprint and/or mechanical feasibility of the incipient break, it is entirely possible to arrange the incipient break on the other face if the choice of positioning of said incipient break is limited.

According to one feature of the invention, the incipient break is a first incipient break positioned on the first face of the fastening flange, the fastening flange comprising at least a second incipient break positioned on the second face of the fastening flange and aligned with the first incipient break along a straight line parallel to the fastening axis. If the spatial environment allows, the fastening flange can comprise incipient breaks on each face that are aligned with each other. Such a configuration improves the precision of the break in the event of an impact. In the event that the vehicle undergoes a violent impact, the separation of the tab into two parts, at the incipient break, is thus initiated on each of the faces and a clean breakage plane, substantially parallel to the direction of the front impact, can thus be more effectively aimed for, which makes it possible to improve the control of the subsequent movement of the rotary electric machine relative to the combustion engine.

According to one feature of the invention, the fastening flange comprises two tabs arranged on either side of the body, the rotary electric machine comprising at least one incipient break formed on each tab. If the fastening flange comprises two tabs, it is advantageous to arrange at least one incipient break on each of them in order to ensure that both tabs break in the event of an impact so that the body of the fastening flange is completely detached.

According to one feature of the invention, the housing is formed by two half-housings, each half-housing comprising a fastening flange with a receiving opening for fastening means centred about the fastening axis, each fastening flange comprising at least one incipient break. The formation of the housing by two half-housings, or two half-shells, makes it easier to position the rotor/stator assembly inside the housing. Having a plurality of fastening flanges, with at least one fastening flange per half-housing, helps to strengthen the mechanical connection between the rotary electric machine and the combustion engine. Nonetheless, in the context of the invention, the rotary electric machine must detach from the combustion engine in the event that the vehicle undergoes a violent impact. This involves the breaking of each of the fastening flanges, regardless of how many there are. In the presence of a plurality of fastening flanges, each of them thus advantageously comprises at least one incipient break so that an impact results in the breaking of all of said fastening flanges.

According to one feature of the invention, the at least one incipient break has a depth of between 10% and 40% of a thickness of the tab, said thickness being measured between the first face and the second face of the fastening flange. As mentioned above, the depth of the incipient break must be determined by reaching a compromise between the desire for a controlled break in the event of a violent impact and the need for mechanical strength of the fastening of the rotary electric machine to the combustion engine. This depth of the incipient break depends equally on the thickness of the tab and on the mechanical strength of the tab, and in particular of the material used to produce this tab and the housing of the rotary electric machine as a whole. It will thus be understood that the ratio between the depth of the incipient break and the thickness of the tab can vary from one rotary electric machine to another as a function of the type of material used. It has been stated that it is the at least one incipient break that has a depth of between 10% and 40% of a thickness of the tab, insofar as this depth value can equally be achieved with a single incipient break if a single incipient break is provided on the tab or by adding together the depths of two incipient breaks if these two incipient breaks are aligned on a fastening tab on which they are arranged on opposite faces. If, for reasons of mechanical footprint, it is not possible to implement aligned incipient breaks on each face, it is thus instead possible to implement a single incipient break on a single face, the depth of which is equivalent to the sum of the depths of two aligned incipient breaks.

According to one feature of the invention, the incipient break has a curvature oriented around the body. A curved incipient break makes it possible in particular to partially follow an outline of the receiving opening of the body. This allows a cleaner break in the event of an impact and offers the assurance that a break will only occur on the tab. The risk of a break extending beyond the tab and being able to cause additional damage is greatly limited.

According to one feature of the invention, the incipient break extends along the whole length of the tab in a direction perpendicular to the fastening axis. Such a configuration is preferred if the surrounding mechanical footprint and/or the structure of the rotary electric machine allows it. Like most of the features described above, this configuration ensures a cleaner, more precise break after an impact.

According to one feature of the invention, the tab is configured to break at the incipient break when the vehicle undergoes a violent impact with an impact force greater than a threshold value of the order of 4,400 N. This threshold value is for example defined for a machine of the order of 10 kg. Such an impact force threshold value is sufficiently high to prevent the fastening flange from breaking during normal operation of the rotary electric machine, but also sufficiently low so that the fastening flange breaks at the incipient break as a result of the vehicle undergoing a violent impact.

The invention also relates to an engine assembly of a vehicle, comprising a combustion engine, a rotary electric machine as described above, and fastening means connecting the rotary electric machine to the combustion engine, the fastening means being arranged facing a protective part of the combustion engine. The breaking of the fastening flanges thus makes it possible to prevent the fastening means from striking and damaging the protective part, in particular a part protecting the intake manifold of the combustion engine, and making the situation worse.

Other features and advantages of the invention will become more clearly apparent from the following description and from a number of exemplary embodiments provided by way of non-limiting indication with reference to the appended schematic drawings, in which:

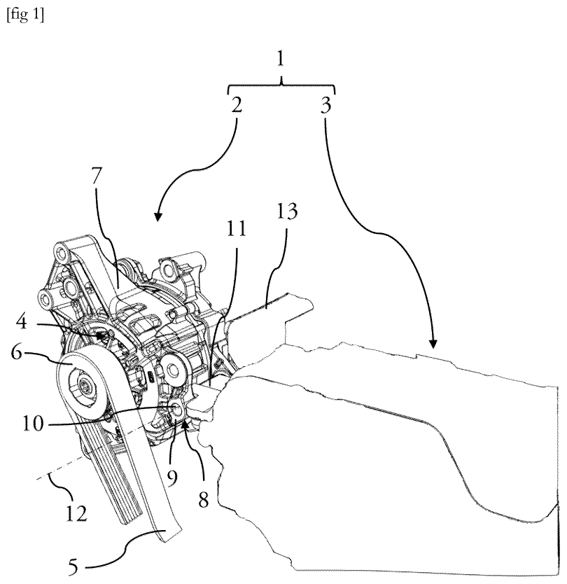

FIG. 1 is a partial depiction of a vehicle engine assembly comprising a rotary electric machine according to the invention and a combustion engine to which the rotary electric machine is fastened at least by a fastening flange,

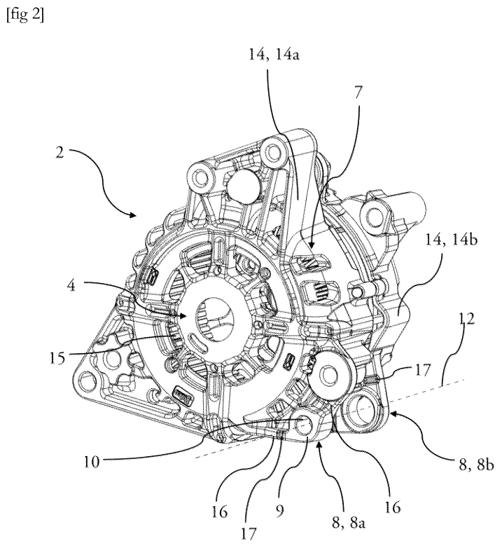

FIG. 2 is a perspective view of the rotary electric machine according to the invention, in particular showing two fastening flanges respectively formed on a half-housing of the rotary electric machine, each fastening flange having at least one incipient break,

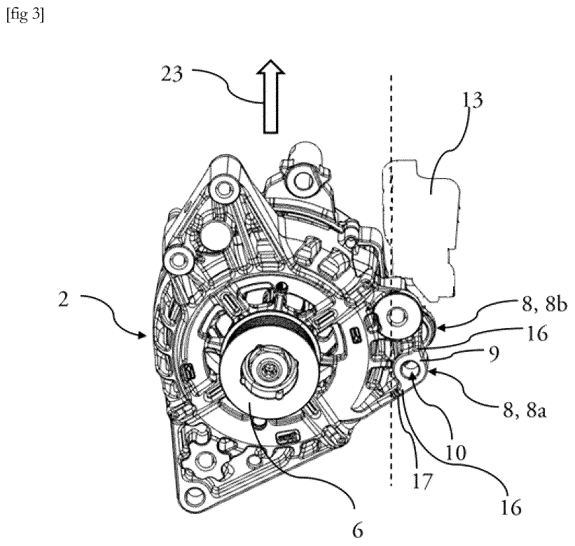

FIG. 3 is a perspective view of the rotary electric machine according to the invention and a protective cover also visible in FIG. 1, here without the associated combustion engine, this view from the front of the vehicle making it possible to appreciate the transverse positioning of the rotary electric machine relative to the protective cover, and the benefit of the incipient breaks on the fastening flanges,

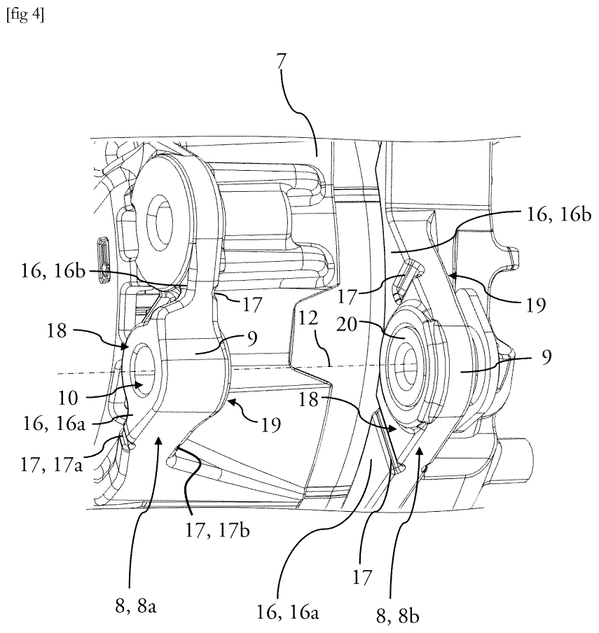

FIG. 4 is a first detailed view of the fastening flanges of the rotary electric machine in FIG. 2, seen in perspective from the front of the vehicle,

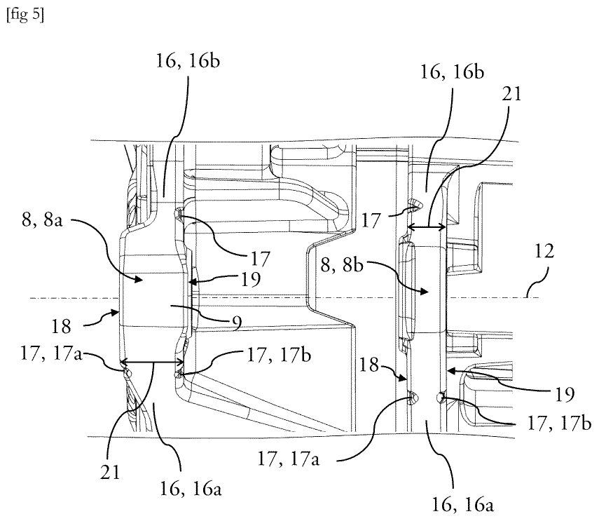

FIG. 5 is a second detailed view of the fastening flanges of the rotary electric machine in FIG. 2, seen from the side,

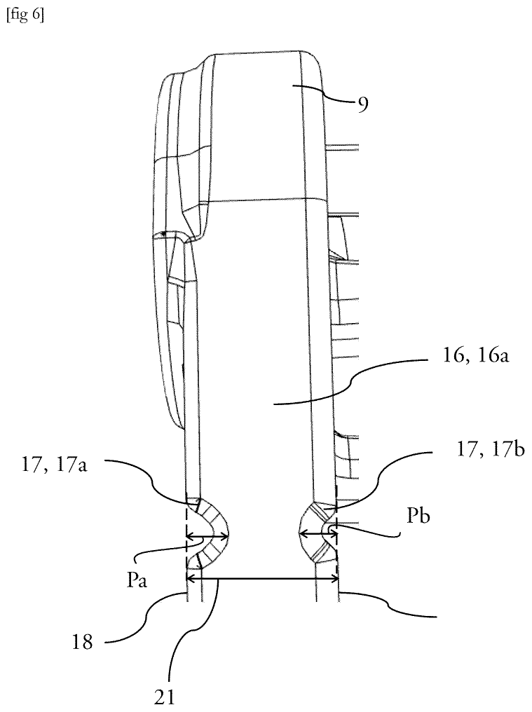

FIG. 6 is a detail view of a first case in which a tab of a fastening flange comprises two aligned incipient breaks formed on two opposite faces of this tab,

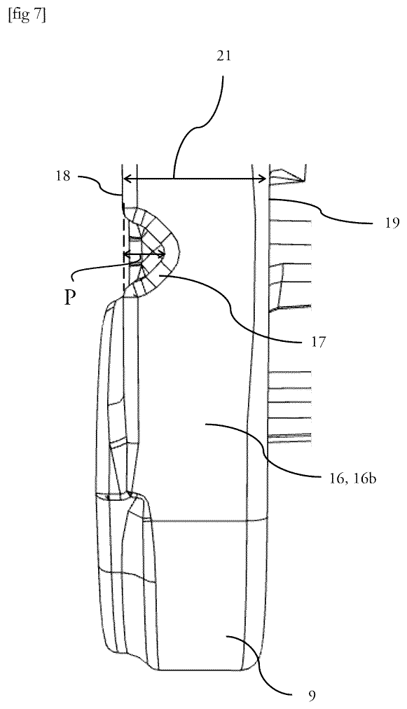

FIG. 7 is a detail view of a second case in which a tab of a fastening flange comprises a single incipient break,

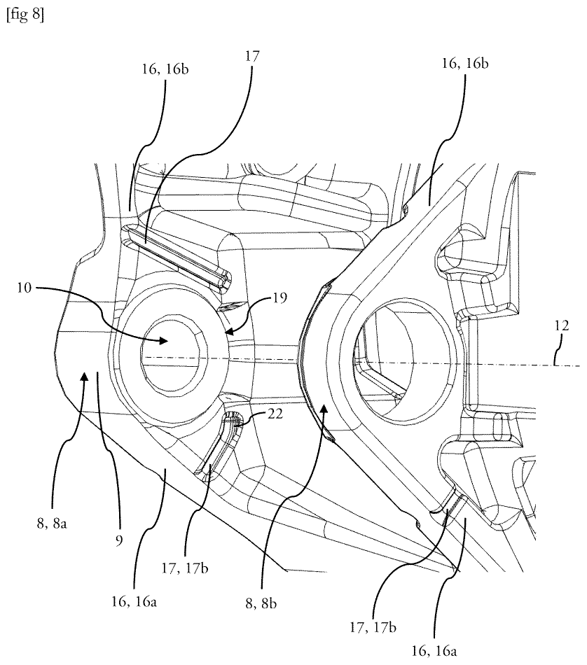

FIG. 8 is a third detailed view of the fastening flanges of the housing of the rotary electric machine in FIG. 2, seen in perspective from the rear of the vehicle.

FIG. 1 shows an engine assembly 1 that can be incorporated into an automotive vehicle. The engine assembly 1 comprises a rotary electric machine 2 and a combustion engine 3 that interact with each other. The rotary electric machine 2 comprises a rotor/stator assembly 4 connected to a belt 5 which, is a manner not illustrated, is also connected to a crankshaft of the combustion engine 3. The rotary electric machine 2 is thus capable of interacting with the combustion engine 3 by means of the belt 5.

Here, the rotary electric machine 2 acts as a starter-alternator, capable of performing both a function of assisting the starting of the automotive vehicle and an electrical energy recovery function. When the vehicle is started, a rotor of the rotor/stator assembly 4 is set in rotation, via its magnetic elements and for example permanent magnets, by a magnetic field created as a result of the supply of electricity to a winding of the stator, the rotation of the rotor then driving a pulley 6 arranged at the end of an output shaft of the rotor and around which the belt 5 is arranged, then making it possible to drive the combustion engine 3. Conversely, when the vehicle is running, the combustion engine 3 drives the movement of the belt 5, which in turn rotates the rotor, via the pulley 6, and the rotor/stator interaction and the electronic components associated with the winding of the stator make it possible to convert mechanical energy into electrical energy.

The rotor/stator assembly 4 of the rotary electric machine 2 is housed in a housing 7. The housing performs the function of protecting and mechanically holding the rotor/stator assembly 4, and only the pulley 6 associated with the rotor extends outside the housing 7 so that the movement can be transmitted from the rotor to the belt 5 or vice versa.

It will be understood from the above that the rotary electric machine 2 and the combustion engine 3 mechanically interact with each other and must therefore be mechanically connected to each other securely and stably. As a result, the engine assembly 1 comprises one or more fastening means providing the mechanical connection between the rotary electric machine 2, more particularly the housing 7 of the rotary electric machine 2, and the combustion engine 3. To this end, the housing 7 comprises at least one fastening flange 8, which comprises a body 9 defining an opening 10, and the combustion engine 3 comprises a fastening member 11 also provided with an opening, said opening not being visible in FIG. 1.

The openings of the at least one fastening flange 8 and of the fastening member 11 are aligned with each other and centred about a fastening axis 12. The associated fastening means can for example be a fastening screw or a threaded rod, which extends axially along the fastening axis 12 through all of the openings and which interacts with at least one nut to thus ensure that mechanical connection between the rotary electric machine 2 and the combustion engine 3. It should be noted that only the fastening axis 12 is visible in FIG. 1, the fastening means having been removed in order to make the at least one fastening flange 8 more particularly visible.

As illustrated in FIG. 1, the arrangement of the engine assembly 1 is configured here so that the rotary electric machine 2 is arranged laterally facing a lateral face of the combustion engine 3 on which all or part of an exhaust manifold is arranged.

In this arrangement, the fastening means and the associated fastening flange 8 are positioned facing, with respect to the longitudinal direction of the fastening axis 12 along the lateral face of the combustion engine, a part 13 for protecting the intake manifold, which protrudes from said lateral face of the combustion engine. Such a protective part 13 theoretically prevents damage to the intake manifold and/or to the connection of an air/fuel supply hose to this manifold.

The protective part 13 is not however configured to withstand an impact force resulting from a violent impact. In particular, the protective part 13 can consist of a thin bent metal sheet. If the vehicle undergoes a violent impact, for example as a result of the vehicle colliding with an obstacle or another vehicle, the theoretical position of the rotary electric machine 2 relative to the combustion engine 3 can be modified by the deformation of the fastening means and the rotary electric machine can then come into contact with the protective part 13 and there is a risk that said part will not withstand such an impact. This can thus seriously damage the intake manifold and create a fuel leak that might greatly worsen the situation of the vehicle beyond the impact undergone.

One solution to this problem is illustrated more precisely in FIG. 2, which shows the rotary electric machine 2 and in particular the at least one fastening flange 8.

It can be seen in FIG. 2 that the housing 9 is made up of two half-housings 14 fastened to each other to protect the rotor, removed here in order to simplify the figure, and the stator 15 of the rotor/stator assembly 4, and each of these half-housings 14 comprises a fastening flange 8 arranged on the periphery of said half-housings 14. The rotary electric machine thus comprises a first half-housing 14a provided with a first fastening flange 8a and a second half-housing 14b provided with a second fastening flange 8b.

Each fastening flange 8, 8a, 8b is integrally formed with the half-housing 14, 14a, 14b associated therewith. Here, each half-housing is a casting that is subsequently added to and screwed to the other half-housing and the fastening flanges 8 are formed during the casting operation used to obtain this half-housing.

As described above, the fastening flanges 8 each comprise a body 9 that defines an opening 10 configured to be centred about the fastening axis 12. Each fastening flange 8 also comprises at least one tab 16 mechanically connecting the body 9 of the fastening flange 8 to the half-housing 14 in question. The mean thickness of a tab is substantially the same as the thickness of the body, in particular to ensure mechanical strength of the body of the fastening flange so that there is no risk that it will break under the effect of the vibrations generated during running at the join between the combustion engine and the rotary electric machine.

The distinctive feature of the rotary electric machine 2 according to the invention is that each fastening flange 8 comprises at least one incipient break 17 formed on one of the tabs 16. Preferably, if the body of the fastening flange is held by several tabs, each tab 16 of this fastening flange 8 comprises an incipient break 17.

It will be understood that it is at this incipient break 17, which forms an area of locally reduced thickness of the tab, that the material will break, that is, the tab 16 will break, as a priority. In the event that the vehicle undergoes a violent impact, it is thus the tabs 16 of the fastening flanges 8 that will break, thus detaching part of the fastening flanges 8 from the rest of the rotary electric machine 2. More particularly, in the event of a violent impact, the presence of an incipient break 17 on a tab 16 generates the separation of the corresponding tab into two parts, with one part of the tab remaining rigidly connected to the corresponding housing or half-housing and one part of the tab connected to the body 9 of the fastening flange still held in place on the fastening member 11 of the combustion engine via the fastening means.

The mechanical connection between the rotary electric machine 2 and the combustion engine is thus interrupted in the event of a violent impact due to the presence of one or more incipient breaks, thus preventing elements of the engine assembly, whether this is the housing of the rotary electric machine or the fastening means held in place on the combustion engine, from coming into contact with the protective part described above. Any worsening of the incident responsible for the impact to the vehicle via a fuel leak resulting from damage to the intake manifold of the combustion engine is thus prevented.

FIG. 3 shows a view of the rotary electric machine 2 and the protective part 13 alone, without the combustion engine to which it is attached. This figure has a viewing angle that makes it possible to appreciate the benefit of the incipient breaks and of their location on the tabs of the at least one fastening flange. As a result of the vehicle undergoing a violent impact, that is a front or substantially front impact of the vehicle against an obstacle or another vehicle, with a direction of the impact force as shown by the white arrow in FIG. 3, the housing of the rotary electric machine 2 is likely to move in this direction relative to the combustion engine and therefore relative to the protective part 13 once the tabs of the fastening flanges have broken.

Due to the incipient breaks 17, during the impact undergone by the vehicle, the tabs 16 are broken in a predetermined location, in a breakage plane shown by a dashed line and comprising both the direction of the impact and the direction of alignment of the incipient breaks. It should be noted that the protective part is arranged on the same side of this plane as the portions of the fastening flanges 8, that is the body 9 and part of the tabs, that remain in place on the combustion engine. The rest of the rotary electric machine can move relative to the combustion engine with controlled, and therefore minimal, risk of meeting the protective part 13. In other words, the rotary electric machine 2 does not hit or only lightly hits the protective part 13, which can remain in position and thus remain able to protect the intake manifold.

As mentioned, the incipient break 17 forms an area of locally reduced thickness of the tab, measured in the longitudinal direction, it being understood that the main component of the impact force when the vehicle undergoes a violent impact, that is a front impact, is a longitudinal component. This locally reduced thickness formed by the incipient break 17 can equally be made on the tab after production of the corresponding housing of the rotary electric machine, in particular by machining a notch, or be formed directly in the material of the tab 16 during a step of injection moulding or casting the corresponding housing.

The features of each incipient break 17, such as the length or depth thereof, are defined as a function of a compromise according to which said incipient breaks 17 must force the breaking of the tabs 16 of the fastening flanges 8 when the vehicle undergoes a violent impact, but must not affect the stiffness and strength of these tabs 16 under the effect of vibrations or other standard mechanical stresses during the normal operation of the engine assembly. As will be set out in detail below, the compromise to be found for these features depends in particular on a thickness of the tab 16 and can be affected by the mechanical footprint of the surrounding engine assembly around the tab 16.

FIG. 4 is a more detailed view of the first fastening flange 8a and the second fastening flange 8b of the rotary electric machine described and illustrated in FIG. 2.

FIG. 4 shows in particular that each fastening flange 8 comprises a first face 18 and a second face 19 on the opposite side from the first face 18, each of these faces 18, 19 being perpendicular, or substantially perpendicular due in particular to manufacturing tolerances, to the fastening axis 12 of the fastening flanges 8. Here, the first face 18 of the fastening flanges 8 is the face that is oriented towards the front of the vehicle, so that it is facing a potential front impact undergone by the vehicle.

In addition, each fastening flange 8 comprises here two tabs 16, and FIG. 4 shows that each of the tabs 16 comprises at least one incipient break 17 in order to ensure that the two tabs 16 of the fastening flange 8 break correctly.

Preferably, the incipient breaks 17 are positioned on the first face 18 of each fastening flange 8, that is more generally on the face 18, 19 that is directly facing the road setting in which the potential impact will occur.

This can particularly be seen on the second fastening flange 8b, either in FIG. 4 or FIG. 5 in particular. This second fastening flange 8b comprises a first tab 16a and a second tab 16b arranged on either side of the body 9, each of these tabs being provided with an incipient break 17 on the first face 18. The two tabs 16 of the second fastening flange 8b can thus break simultaneously or substantially simultaneously and precisely, thus causing optimum detachment of the body 9 from the rest of the housing in the event of a significant impact. It should be noted that in FIG. 4 the second fastening flange 8b comprises a sleeve 20 in the receiving opening of the body 9. For reasons of clarity and visibility of the incipient breaks on the tabs, the sleeve 20 is not illustrated in all of the figures.

As can be seen in FIG. 4, the incipient breaks 17 formed on the same fastening flange can have different dimensions. More particularly, the incipient break 17 formed on the first face 18 of the first tab 16a of the second fastening flange 8b extends over a whole transverse dimension of the first tab 16a, in a direction perpendicular to the fastening axis 12, while the incipient break 17 formed on the first face 18 of the second tab 16b of this same second fastening flange 8b only extends over part of this equivalent transverse dimension of the second tab. It should be noted that in order to promote a controlled break under the impact force, it can be preferable for the incipient break 17 to extend over the whole transverse dimension of the tab 16 in order to improve the precision of the cutting of the tab into two parts on breaking. However, if the mechanical footprint surrounding the fastening flange 8 does not allow this, it is possible to implement an incipient break 17 having a smaller transverse extent, as is the case for the incipient break 17 of the second tab 16b of the second fastening flange 8b.

In addition, the second fastening flange 8b also comprises an incipient break on its second face 19, as will be described in detail below with reference to FIGS. 5 and 8, which show this second face more clearly.

The first fastening flange 8a also comprises a first tab 16a and a second tab 16b, with an incipient break 17 on each of them. However, the distribution of the incipient breaks is different on this first fastening flange insofar as on the first tab 16a, an incipient break is arranged on the first face 18 and on the second face 19 of this first fastening flange 8a, while the second tab 16b has a single incipient break 17 arranged on the second face 19 of the first fastening flange 8a. Although such positioning of a single incipient break on the second face is not the most advantageous, it is a possible alternative in the event that it is not possible to position the incipient break on the first face 18. In this instance, the geometry of the first face 18 of the first fastening flange 8a, particularly on the second tab 16b thereof, does not make it possible to implement an incipient break 17 on the first face 18. The incipient break 17 of the second tab 16b of the first fastening flange 8a is therefore positioned on the second face 19.

FIG. 5 is a side view of the fastening flanges 8 as illustrated in the preceding figures. The side view illustrates more clearly a feature of the rotary electric machine according to which the first tab 16a of each fastening flange 8 comprises a first incipient break 17a positioned on the first face 18 of each fastening flange 8 and a second incipient break 17b positioned on the second face 19 of each fastening flange 8.

For each first tab 16a of the two fastening flanges 8, the first incipient break 17a and the second incipient break 17b are aligned with each other along a straight line parallel to the fastening axis 12. This configuration is ideal as it makes it possible to determine with great precision where the first tab 16a must be broken, and improves the cleanness of the break that must extend from the first face 18 to the second face 19 of the first tab 16a.

As with certain configurations mentioned above, implementing a first incipient break 17a and a second incipient break 17b aligned with each other is advantageous, but is only feasible if the spatial configuration of the fastening flange 8 allows it.

For the two fastening flanges 8, this configuration can be implemented on the first tab 16a, but not on the second tab 16b.

As described above, the spatial configuration of the second tab 16b of the first fastening flange 8a does not make it possible to implement an incipient break 17 on the first face 18. With regard to the second fastening flange 8b, in this case it is not possible to implement an incipient break 17 on the second face 19 of the second tab 16b.

Regardless of the configuration selected for forming at least one incipient break on a tab of a fastening flange, namely either two incipient breaks 17a, 17b formed on faces 18, 19 on opposite sides of the tab and aligned with each other with reference to the fastening axis 12, or a single incipient break formed on one of the faces, the ratio between the thickness of remaining material of the tab and the void created by the incipient break or breaks must be substantially the same and meet the criteria defined by the desired compromise between the mechanical strength of the tab and the possibility of breakage in the event of a violent impact. In other words, the presence of a single incipient break on a single face as mentioned for the second tabs 16b of each fastening flange can be offset by the increase in the depth of the single incipient break 17.

More particularly, the depth of each incipient break 17 depends on the thickness 21 of the tabs 16 on which the incipient break or breaks is/are positioned and the presence or absence of another incipient break on the opposite face. As mentioned above, the at least one incipient break 17 associated with a tab 16 thus has a depth of between 10% and 40%, and for example more specifically between 15% and 35%, of the thickness 21 of the tab 16 in the area in which said at least one incipient break 17 is positioned. The thickness of the tab and the depth of the incipient break are measured parallel to the fastening axis 12. The thickness of the tab is measured between the first face 18 and the second face 19 thereof, while the depth of the incipient break is measured between the face in which the incipient break is formed and the bottom of this incipient break.

In a first case, illustrated schematically in FIG. 6, here the case of the first tabs 16a of the fastening flanges 8a, 8b, with the tab comprising a first incipient break 17a and a second incipient break 17b aligned with each other, it is the sum of the depths Pa, Pb of each incipient break 17a, 17b that should be taken into account, and it is this sum of the depths that has a value of between 10% and 40% of the thickness 21 of the tab 16 mentioned. Here, the depth of each incipient break is substantially the same, but this does not limit the invention provided that the sum of the depths meets the criterion mentioned above.

In a second case, illustrated schematically in FIG. 7, here the case of the second tabs 16b of the fastening flanges 8a, 8b, with the tab comprising a single incipient break 17, it is the depth P of the single incipient break 17 that should be taken into account, and it is this depth value P that is between 10% and 40% of the thickness 21 of the tab 16 mentioned.

As stated, in each case, the boundaries of the range within which the value of the depth of an incipient break or the value of the sum of the depths must fall are selected taking into account the compromise between the desire for a controlled break in the event of a violent impact and the need for mechanical strength of the fastening of the rotary electric machine to the combustion engine in standard operating mode, without the vehicle undergoing a violent impact.

The view in FIG. 8 mainly shows the second face 19 of each fastening flange. As a result, the incipient breaks 17 particularly visible in FIG. 8 are the incipient breaks 17 positioned on the second face 19 of the fastening flanges 8, namely the second incipient break 17b of the first tab 16a of the first fastening flange 8a, the incipient break 17 of the second tab 16b of the first fastening flange 8a, and the second incipient break 17b of the first tab 16a of the second fastening flange 8b.

One feature particularly visible in FIG. 8 can be seen in the second incipient break 17b of the first tab 16a of the first fastening flange 8a, which has a curvature 22 oriented around the body 9 of the first fastening flange 8a.

This curvature 22 also helps to improve the precision of the breaking of the tab 16. More particularly, the curvature 22 ensures that only the tab 16 breaks and that the break is correctly delimited. This makes it possible to prevent the unwanted breaking of another part of the housing of the rotary electric machine arranged close to the tab 16.

Of course, the invention is not limited to the examples that have just been described, and numerous modifications can be made to these examples without departing from the scope of the invention.

The invention as it has just been described achieves the stated aim, and makes it possible to propose a rotary electric machine comprising fastening flanges capable of breaking in the event of a violent impact and thus preventing additional consequences resulting from such a violent impact. Variants that are not described here can be implemented without departing from the context of the invention, provided that, in accordance with the invention, they comprise a rotary electric machine according to the invention.

1. Rotary electric machine for a vehicle, comprising a housing, a rotor/stator assembly housed in said housing and at least one fastening flange integrally formed with the housing and configured to mechanically connect the rotary electric machine to a combustion engine of said vehicle, the fastening flange comprising a body provided with a receiving opening for fastening means centred about a fastening axis, and at least one tab connecting the body to the housing, wherein the fastening flange comprises at least one incipient break formed on the tab and configured so that said tab breaks in the event that the vehicle undergoes a violent impact.

2. Rotary electric machine according to claim 1, wherein the fastening flange comprises a first face and a second face on the opposite side from the first face, the first face and the second face being perpendicular to the fastening axis, the incipient break being positioned on the first face or on the second face.

3. Rotary electric machine according to claim 2, wherein the incipient break is a first incipient break positioned on the first face of the fastening flange, the fastening flange comprising at least a second incipient break positioned on the second face of the fastening flange and aligned with the first incipient break along a straight line parallel to the fastening axis.

4. Rotary electric machine according to claim 1, wherein the fastening flange comprises two tabs arranged on either side of the body, the rotary electric machine comprising at least one incipient break formed on each tab.

5. Rotary electric machine according to claim 1, wherein the housing is formed by two half-housings, each half-housing comprising a fastening flange with a receiving opening for fastening means centred about the fastening axis, each fastening flange comprising at least one incipient break.

6. Rotary electric machine according to claim 1, wherein the at least one incipient break has a depth of between 10% and 40% of a thickness of the tab, said thickness being measured between the first face and the second face of the fastening flange.

7. Rotary electric machine according to claim 1, wherein the incipient break has a curvature oriented around the body.

8. Rotary electric machine according to claim 1, wherein the incipient break extends along the whole length of the tab in a direction perpendicular to the fastening axis.

9. Rotary electric machine according to claim 1, wherein the tab is configured to break at the incipient break when the vehicle undergoes a violent impact with an impact force greater than a threshold value of the order of 4,400 N.

10. Engine assembly of a vehicle, comprising a combustion engine, a rotary electric machine according to claim 1, and fastening means connecting the rotary electric machine to the combustion engine, the fastening means being arranged facing a protective part of the combustion engine.

11. Rotary electric machine according to claim 2, wherein the fastening flange comprises two tabs arranged on either side of the body, the rotary electric machine comprising at least one incipient break formed on each tab.

12. Rotary electric machine according to claim 2, wherein the housing is formed by two half-housings, each half-housing comprising a fastening flange with a receiving opening for fastening means centred about the fastening axis, each fastening flange comprising at least one incipient break.

13. Rotary electric machine according to claim 2, wherein the at least one incipient break has a depth of between 10% and 40% of a thickness of the tab, said thickness being measured between the first face and the second face of the fastening flange.

14. Rotary electric machine according to claim 2, wherein the incipient break has a curvature oriented around the body.

15. Rotary electric machine according to claim 2, wherein the incipient break extends along the whole length of the tab in a direction perpendicular to the fastening axis.

16. Rotary electric machine according to claim 2, wherein the tab is configured to break at the incipient break when the vehicle undergoes a violent impact with an impact force greater than a threshold value of the order of 4,400 N.

17. Engine assembly of a vehicle, comprising a combustion engine, a rotary electric machine according to claim 2, and fastening means connecting the rotary electric machine to the combustion engine, the fastening means being arranged facing a protective part of the combustion engine.

18. Rotary electric machine according to claim 3, wherein the fastening flange comprises two tabs arranged on either side of the body, the rotary electric machine comprising at least one incipient break formed on each tab.

19. Rotary electric machine according to claim 3, wherein the housing is formed by two half-housings, each half-housing comprising a fastening flange with a receiving opening for fastening means centred about the fastening axis, each fastening flange comprising at least one incipient break.

20. Rotary electric machine according to claim 3, wherein the at least one incipient break has a depth of between 10% and 40% of a thickness of the tab, said thickness being measured between the first face and the second face of the fastening flange.
